(19) United States
(12) Patent Application Publication
(10) Pub. No.: US 2014/0351944 A1
(43) Pub. Date: Nov. 27, 2014

(54) SOFTWARE PROTECTING SYSTEM AND ELECTRONIC DEVICE USING THE SAME

(71) Applicants: Fu Tai Hua Industry (Shenzhen) Co., Ltd., Shenzhen (CN); HON HAI PRECISION INDUSTRY CO., LTD., New Taipei (TW)

(72) Inventors: YU-KAI XIONG, Shenzhen (CN); XIN LU, Shenzhen (CN); XIN-HUA LI, Shenzhen (CN)

(73) Assignees: HON HAI PRECISION INDUSTRY CO., LTD., New Taipei (TW); FU TAI HUA INDUSTRY (SHENZHEN) CO., LTD., Shenzhen (CN)

(21) Appl. No.: 14/264,070

(22) Filed: Apr. 29, 2014

(30) Foreign Application Priority Data
May 24, 2013 (CN) 2013101985754

(51) Int. Cl. G06F 21/12

(52) U.S. Cl. CPC G06F 21/12; G06F 21/121
USPC 726/26

(57) ABSTRACT

A software protecting system existing as an independent program in an electronic device protects against misuse of new software to be installed. The protecting system includes an invoking module and an input/output setting module. The invoking module invokes the genuine software in response to user input but the input/output setting module sets input/output functions of the genuine software when the genuine software is run to prevent complete of peripheral functionality during any trial period of use. An electronic device with the software protecting system is also provided.

### BACKGROUND

1. Technical Field

The present disclosure relates to software protection, and particularly to an electronic device and a software protecting system applied in the electronic device for protecting genuine software installed in the electronic device.

2. Description of Related Art

Trial software may be provided to users to give potential users the opportunity to try the program for a limited time and usage. However, if the trial software is fully functional, users may think that there is no need to buy a genuine software, and if the trial software is too limited in function, users cannot fully appreciate and recognize the software.

Therefore, what is needed is a software protecting system to make users fully aware of all the functions of genuine software and protect the genuine software being actually used by the user when the genuine software is in a trial period, to solve the above-mentioned problem.

### BRIEF DESCRIPTION OF THE DRAWINGS

Many aspects of the present disclosure should be better understood with reference to the following drawings. The components in the drawing are not necessarily drawn to scale, the emphasis instead being placed upon clearly illustrating the principles of the present device. Moreover, in the drawing, like reference numerals designate corresponding components throughout the views.

FIG. 1 is a block diagram of an electronic device, in accordance with an exemplary embodiment.

FIG. 2 is a block diagram of a software protecting system applied in the electronic device shown in FIG. 1, in accordance with an exemplary embodiment.

### DETAILED DESCRIPTION

Embodiments of the present disclosure are described with reference to the accompanying drawings.

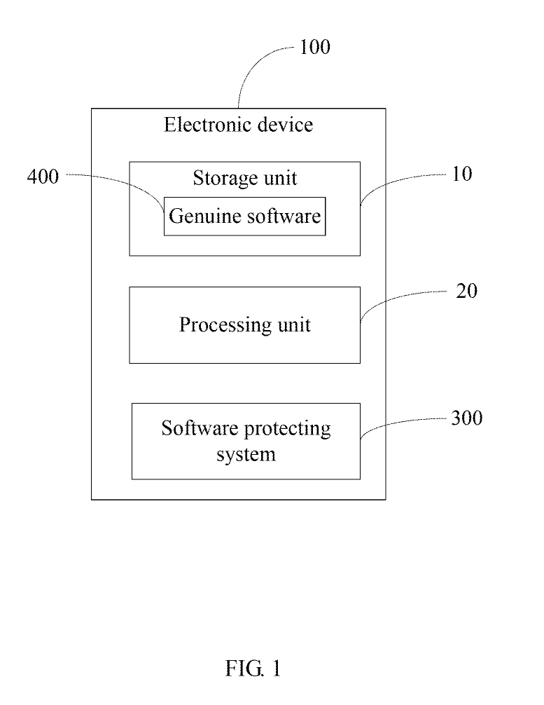

FIG. 1 shows an embodiment of an electronic device 100 which installs and runs a software protecting system 300 and a genuine software 400. In this embodiment, the genuine software 400 is in a trial period, that is, a user has not paid for the genuine software 400 to get a registration number, and the genuine software 400 can only be invoked by the software protecting system 300 if the user wants to investigate the genuine software 400. The software protecting system 300 is used to invoke and present the genuine software 400 in the trial period, for example, to set certain input and output functions for the genuine software 400, such as disabling a function of any printout of data generated by the genuine software 400 when the genuine software 400 is on trial. Thus, the genuine software 400 can be fully operational for the user, but the input/output function of the genuine software 400 can be limited, so the genuine software 400 cannot be fully used or realized by the user. In this embodiment, the electronic device 100 can be, but is not limited to being, a portable computer, a tablet computer, or a desktop computer.

In this embodiment, the electronic device 100 includes a storage unit 10 and a processing unit 20. The storage unit 10 can be a smart media card, a secure digital card, or a flash card. The processing unit 20 can be, but is not limited to being, a central processing unit, a single chip, or a digital signal processor.

The storage unit 10 stores the genuine software 400. The software protecting system 300 includes a number of modules, which are a collection of software instructions executed by the processing unit 20.

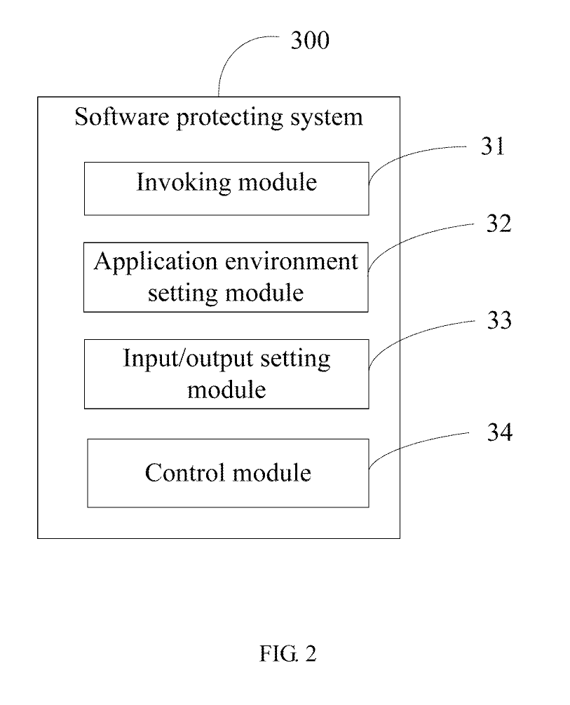

Referring to FIG. 2, in this embodiment, the software protecting system 300 includes an invoking module 31, an application environment setting module 32, an input/output setting module 33, and a control module 34.

The invoking module 31 invokes the genuine software 400 according to a preset invoking request, in response to user input. In this embodiment, the invoked genuine software 400 is within a trial period and cannot be directly run by the electronic device 100.

The application environment setting module 32 sets environment parameters, which support the running of the genuine software 400, according to a hardware configuration of the electronic device 100. In this embodiment, the environment parameters include memory size, operation frequency of the central processing unit, driver size, and the like. For example, if the supporting memory to support the running of genuine software 400 to run is required to be 2 gigabytes (GB), but the actual memory size of the electronic device 100 is 1GB, the application environment setting module 32 sets a virtual memory of 2GB as the environment parameter to support the running of genuine software 400.

The input/output setting module 33 sets input/output functions of the genuine software 400 when the genuine software 400 is in a running state. In detail, the input/output setting module 33 set the input/output functions as preventing users from inputting parameters to a parameter input area of the genuine software 400, the parameters being inputted to the parameter input area are only the default parameters set by the input/output setting module 33 itself, and a printing and saving functions of the genuine software 400 may be set as enabled or disabled. The input/output setting module 33 may also set the input/output function as allowing users to input some parameters to the parameter input area but, for example, preventing the printing and saving functions when the genuine software 400 is in a running state. In this embodiment, the input/output setting module 33 inputs default parameters to the parameter input area by setting the parameter input area as a non-editable area, and when the input/output setting module 33 determines that the non-editable area has been clicked by the user, the input/output setting module 33 automatically loads the default parameters into the parameter input area.

When the genuine software 400 is run by the software protecting system 300, the user either cannot input any parameters at all to the parameter input area, or the user cannot input parameters to parameter input area and cannot print and save any result of data processing which is generated from the default parameters set by the input/output setting module 33. or the user can input certain parameters to the parameter input area, but cannot print and save any result of data processing which is generated from the user input parameters.

The control module 34 detects whether a software crack exists on the computer or not, and deletes one or more installation files of the genuine software 400 to prevent the running of the genuine software 400 if a software crack is detected by the control module 34. In this embodiment, the control module 34 may also determine that a software crack exists if the software protecting system 300 is frequently started and closed down by the user.

The control module 34 further deletes one or more installation files of the genuine software 400 to prevent the running of the genuine software 400 if the number of times that the genuine software 400 has been invoked by the software protecting system 300 reaches a predetermined value, or the time period for starting and running the genuine software 400 expires.

The control module 34 prompts the user to input registration information of the genuine software 400 when the genuine software 400 is invoked by the invoking module 31, and if the user inputs the registration information of the genuine software 400, the control module 34 adds the inputted registration information to the genuine software 400. The use-limitations of the input/output function are then removed, and the user can directly use the genuine software 400 in full and the software protecting system 300 is not required.

The software protecting system 300 in the present disclosure makes the user fully appreciate all the functions of genuine software 400 and protects the genuine software 400 from being misused when the genuine software 400 is in the trial period.

Although the present disclosure has been specifically described on the basis of exemplary embodiments thereof, the disclosure is not to be construed as being limited thereto. Various changes or modifications may be made to the embodiments without departing from the scope and spirit of the disclosure.

What is claimed is:

1. An electronic device comprising:
a storage unit configured to store a genuine software installed and run in the electronic device, wherein the genuine software is in a trial period;
a processing unit; and
a software protecting system comprising a plurality of modules which are collection of instructions executed by the processing unit, the modules comprising:
an invoking module configured to invoke the genuine software stored in the storage unit according to preset invoking request in response to user input; and
an input/output setting module configured to set input/output functions of the genuine software when the genuine software is in a running state.

2. The electronic device as described in claim 1, wherein setting the input/output functions of the genuine software by the input/output setting module comprises: disabling the input/output functions so as to prevent users from inputting parameters to parameter input area of the genuine software, the parameters being inputted to the parameter input area are only the default parameters set by the input/output setting module itself; or allowing users to input certain parameters to the parameter input area, but preventing the printing and saving functions when the genuine software is in a running state.

3. The electronic device as described in claim 2, wherein inputting default parameters to the parameter input area by the input/output setting module comprises:
setting the parameter input area as a non-editable area, when the input/output setting module determines that the non-editable area has been clicked by the user and automatically loads the default parameters into the parameter input area.

4. The electronic device as described in claim 1, wherein the modules further comprises an application environment setting module configured to set environment parameters, which support the running of the genuine software, according to a hardware configuration of the electronic device.

5. The electronic device as described in claim 1, wherein the modules further comprises a control module configured to detect whether a software crack exists on the computer or not, and delete one or more installation files of the genuine software to prevent the running of the genuine software if a software crack is detected by the control module.

6. The electronic device as described in claim 5, wherein the control module is further configured to delete one or more installation files of the genuine software to prevent the running of the genuine software if the number of times that a boot up of the genuine software is invoked by the software protecting system reaches a predetermined value.

7. The electronic device as described in claim 5, wherein the control module is further configured to delete one or more installation files of the genuine software to prevent the running of the genuine software if the time period for starting and running the genuine software expires.

8. The electronic device as described in claim 5, wherein the control module is further configured to prompt the user to input registration information of the genuine software when the genuine software is invoked by the invoking module, and if the user inputs registration information of the genuine software, the control module adds the inputted registration information to the genuine software, thus, the user can directly use the genuine software in full and the software protecting system is not required.

9. A software protecting system applied in an electronic device, the electronic device comprising a storage unit to store a genuine software installed and run in the electronic device, wherein the genuine software is in a trial period, the system comprising:
a plurality of modules which are collection of instructions executed by one or more processing unit of the electronic device, the modules comprising:
an invoking module configured to invoke the genuine software stored in the storage unit according to preset invoking request in response to user input; and
an input/output setting module configured to set input/output functions of the genuine software when the genuine software is in a running state.

10. The software protecting system as described in claim 9, wherein disabling the input/output functions so as to prevent users inputting parameters to parameter input area of the genuine software, the parameters being inputted to the parameter input area are only the default parameters set by the input/output setting module itself; or allowing users to input certain parameters to the parameter input area, but preventing the printing and saving functions when the genuine software is in a running state.

11. The software protecting system as described in claim 10, wherein inputting default parameters to the parameter input area by the input/output setting module comprises: setting the parameter input area as a non-editable area, when the input/output setting module determines that the non-editable area has been clicked by the user and automatically loads the default parameters into the parameter input area.

12. The software protecting system as described in claim 9, the modules further comprises an application environment setting module configured to set environment parameters, which support the running of the genuine software, according to a hardware configuration of the electronic device.

13. The software protecting system as described in claim 9, wherein the modules further comprises a control module configured to detect whether a software crack exists on the computer or not, and delete one or more installation files of the genuine software to prevent the running of the genuine software if a software crack is detected by the control module.

14. The software protecting system as described in claim 13, wherein the control module is further configured to delete one or more installation files of the genuine software to prevent the running of the genuine software if the number of times that the genuine software has been invoked by the software protecting system reaches a predetermined value.

15. The software protecting system as described in claim 13, wherein the control module is further configured to delete one or more installation files of the genuine software to prevent the running of the genuine software if the time period for starting and running the genuine software expires.

16. The software protecting system as described in claim 13, wherein the control module is further configured to prompt the user to input registration information of the genuine software when the genuine software is invoked by the invoking module, and if the user inputs registration information of the genuine software, the control module adds the inputted registration information to the genuine software, thus, the user can directly use the genuine software in full and the software protecting system is not required.
